(19) United States
(12) Patent Application Publication
(10) Pub. No.: US 2004/0215912 A1
(43) Pub. Date: Oct. 28, 2004

(54) Method and apparatus to establish, report and adjust system memory usage

(76) Inventors: George Vergis, Hillsboro, OR (US); Nitin Gupte, Beaverton, OR (US); Yuchen Huang, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/423,189

(22) Filed: Apr. 24, 2003

(51) Int. Cl. G06F 12/00

(52) U.S. Cl. 711/170

(57) ABSTRACT

A method is described that entails reading information from a non volatile storage or memory resource. The information is a threshold or information from which a threshold can be calculated. The information is particularly tailored for an operating environment that a system memory is recognized as being subjected to. The method also entails causing a memory controller to employ the threshold so as to control a rate at which the memory performs activities. The rate is less than that at which the system memory would experience a functional failure while being subjected to the operating environment

### FIELD OF INVENTION

The field of invention relates generally to computing system optimization; and, more specifically, to a method and apparatus to establish, report and adjust system memory usage.

### BACKGROUND

Computing systems include a system memory. A system memory is generally viewed as a memory resource: a) from which different components of the computing system may desire to obtain data from; and, 2) to which different components of the computing system may desire to store data within. FIG. 1 shows a simple diagram of a portion of a computing system that includes a system memory 106 and a memory controller 101. Because different computing system components often desire to invoke the resources of the system memory quasi-simultaneously (e.g., a plurality of different computing system components “suddenly” decide to invoke the system memory resources within a narrow region of time), the memory controller 101 is responsible for managing the order and the timing in which the different components are serviced by the system memory 106.

FIG. 1 is drawn to provide some insight into a typical application. Note that the memory controller 101 is configured to manage the various system memory invocations that are generated by: 1) one or more processors (e.g., through a processor front side bus 108); 2) a graphics controller (e.g., through graphics controller interface 109); and, 3) various peripheral components of the overall computing system (e.g., through system bus interface 110 (e.g., a Peripheral Components Interface (PCI) bus interfacce). The system memory 106 may be constructed from a number of different memory semiconductor chips and may be simplistically viewed as having an address bus 104 and a data bus 105. Specific memory cells are accessed by presenting corresponding address values on the address bus 104. The data value being read from or written to a specific memory cell appears on data bus 105.

Memory controllers may be equipped with an ability to regulate the stress or usage that is applied to the system memory 106. For example, as observed in FIG. 1, memory controller 101 includes a threshold register 102 that stores a threshold value. The threshold value is used to control the rate at which the system memory 106 is involved with various activities (e.g., various accesses such as reads, writes, activations, etc.); and, by so doing, controls the usage or stress that is applied to the system memory 106. The memory controller 101, in response to the threshold value, is designed to pace the rate at which activities are applied to the system memory 106 so that the usage applied to the system memory 106 does not over-stress the system memory 106.

As a simplistic example, FIG. 2 shows some examples of how different read and write rates may be applied to a system memory in response to different threshold values. A first depiction 201 shows a maximum rate at which reads and writes (signified by “R”s and “W”s, respectively) may be applied to a system memory according to a first threshold value. A second depiction 202 shows a maximum rate at which reads and writes may be applied to a system memory according to a second threshold value. As the first depiction 201 clearly shows more reads and writes (over approximately the same time period) as compared to the second depiction 202, the first threshold allows for a higher maximum rate of reads and writes than the second threshold. Note that for simplicity both depictions 201, 202 show that reads and writes occur alternatively with respect to one another. In practice, consecutive reads and consecutive writes often occur.

The threshold value that is used by the computing system (or information from which the threshold value can be computed) may be stored in a non volatile memory region such as a region of Electrically Erasable Programmable Read Only Memory (EEPROM) resources. For example, the threshold value may be stored within the Basic Input Output System (BIOS) memory region 107 or the Serial Presence Detect (SPD) memory region 114 of the computing system. The BIOS memory region 107 stores instructions that are used early on in a computing system's start up phase. The SPD memory region 114 stores information that describes and/or characterizes the system memory 106.

### FIGURES

The present invention is illustrated by way of example, and not limitation, in the Figures of the accompanying drawings in which

FIG. 1 shows a portion of a prior art computing system;

FIG. 2 shows examples of different rates at which activity may be applied to a computing system's system memory;

FIG. 3 shows a methodology by which a threshold value for a memory controller may be adjusted over the course of operation for a computing system;

FIG. 4 shows a more detailed embodiment of a portion of the methodology of FIG. 3;

FIG. 5 shows an embodiment of a look-up table that can be used to adjust a memory controller's threshold value over the course of its operation;

FIG. 6 shows an embodiment of a portion of a computing system that may be used to adjust a memory controller's threshold value over the course of its operation;

FIGS. 7a through 7c show relationships between device power, bandwidth and ambient temperature;

FIG. 8 shows a depiction of a technique by which power consumption can be modeled;

FIGS. 9a and 9b show techniques for preventing a functional failure with respect to the operation of a computing system's system memory; and,

FIG. 10 shows exemplary depictions of various rates at which a computing system's battery power is consumed as a function of a system memory's self refresh rate.

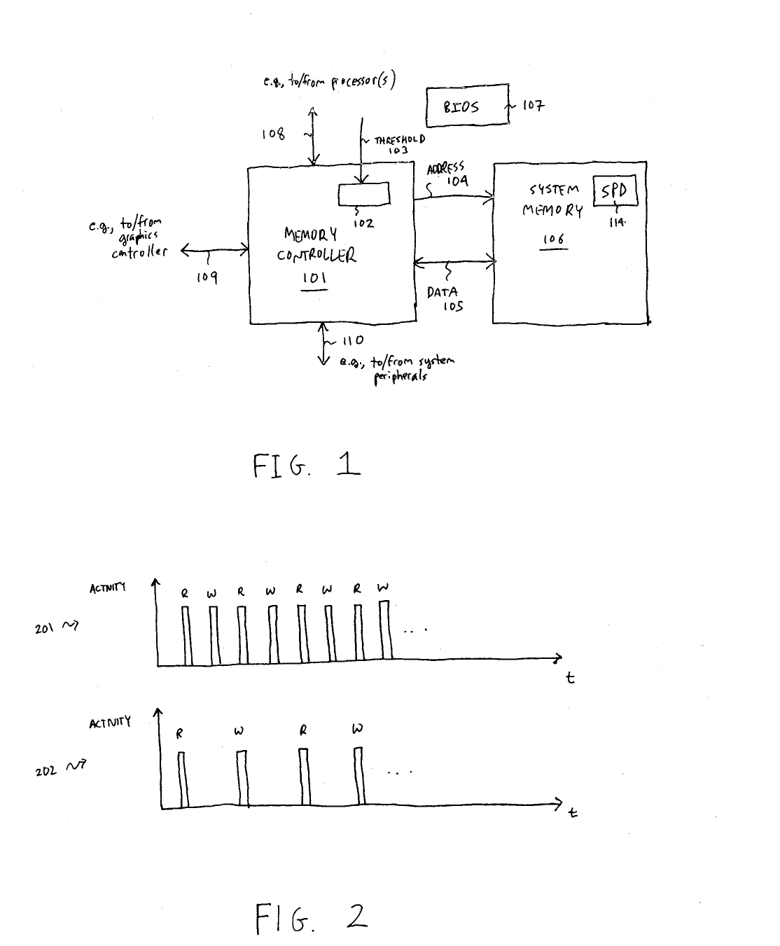

### DETAILED DESCRIPTION

Computing System Capable Of Changing Its Threshold Value

It is useful to include within the computing system information that is sufficient to obtain or derive a threshold value that is well suited for whatever operating environment the system memory happens to be subjected to. A computer system so enabled is capable of using more than one threshold value instead of only one threshold value; and, as a consequence, is also capable of replacing a current threshold value with another threshold value in response to a detected change in the system memory's operating environment.

For example, an increase in the ambient temperature surrounding the system memory's semiconductor chip(s) may trigger a change to a new threshold value that lowers the maximum allowable activity rate that is applied to the system memory (so as to keep the internal “junction” temperature of the semiconductor chip(s) at or below a critical level above which the probability of their failure is significantly accelerated). Likewise, a decrease in the ambient temperature surrounding the system memory's semiconductor chip(s) may trigger a change to a new threshold value that increases the maximum allowable activity rate that is applied to the system memory (so as to allow the system memory to operate closer to its theoretical maximum sustainable performance at the newer, cooler ambient temperature).

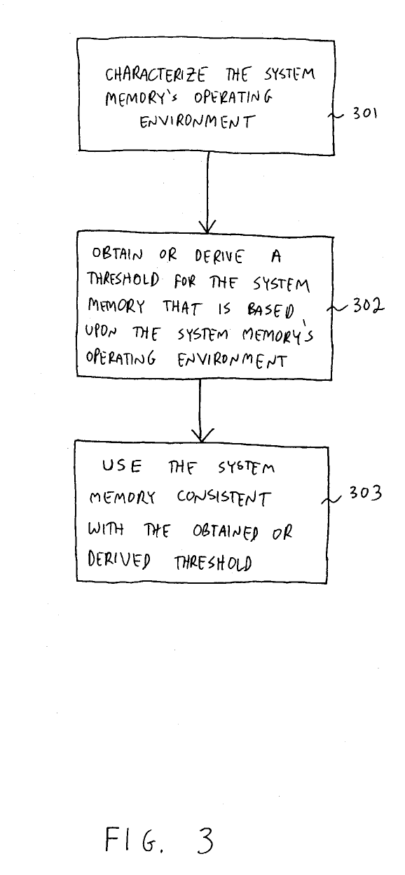

FIG. 3 shows a methodology that can be executed by a computing system that is capable of using multiple threshold values. According to the methodology of FIG. 3, the system memory's operating environment is characterized 301. A more detailed discussion of various operating environment embodiments is provided below with respect to FIG. 5. Generally, however, an “operating environment” is some description of one or more conditions (e.g., temperature, read/write percentage, etc.) to which the system memory is subjected and from which a limit on the usage of the memory (e.g., by limiting the maximum rate at which the various activities are applied to the system memory) can be determined. Once the operating environment of the system memory is characterized 301, a threshold is obtained or derived 302 for the system that is based upon the system memory's operating environment. Once the threshold is obtained or derived, it is used 303 to limit the rate at which activity is applied to the system memory.

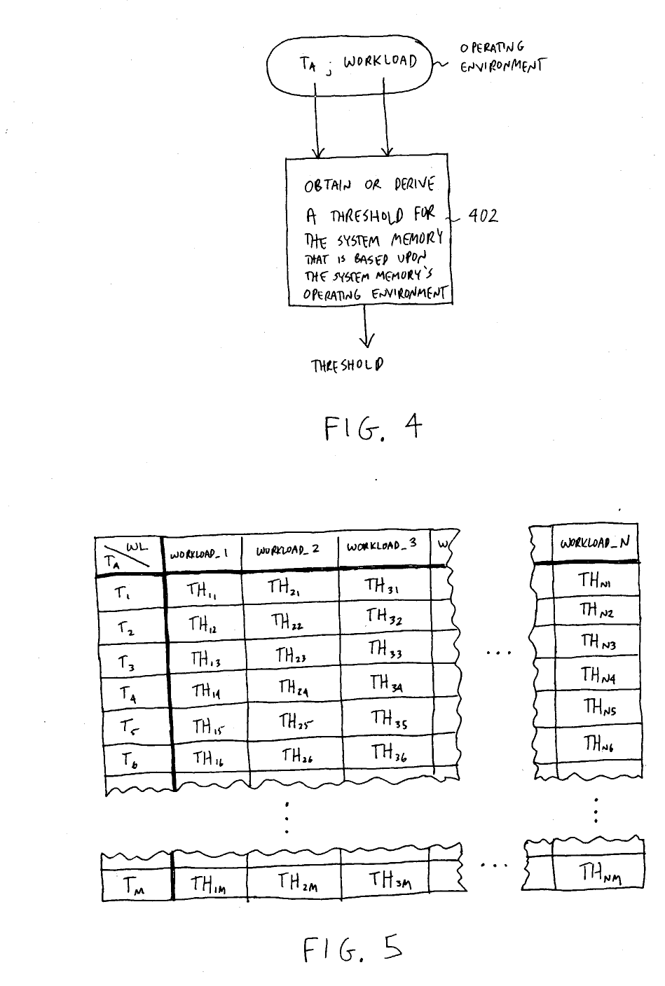

FIG. 4 shows a more detailed depiction of a portion of the methodology of FIG. 3. Specifically, FIG. 4 shows a threshold that is obtained or derived 402 in response to an operating environment that includes the system memory's ambient temperature and the system memory's workload. The workload of a system memory is some description of the manner in which a memory device is being used by its corresponding computing system. A workload may therefore include a description of one or more of the following: 1) the read/write percentage of system memory accesses (e.g., as just a few examples: 75% read and 25% write; 50% read and 50% write; 25% read and 75% write;, etc.); 2) page hit/page empty/page miss percentage (e.g., as just one example: 50% page hit/25% page empty/25% page miss); 3) burst length; and, 4) a particular “standby” mode that the memory device is placed into. Apsects of these are discussed in more detail immediately below.

The read/write percentage reflects the percentage of memory accesses that are a read operation and the percentage of memory accesses that are a write operation. The read/write percentage may reflect how the computing system is being used. For example, if the computing system is being heavily used to download information from a network into system memory—the write percentage would be expected to be higher than the read percentage. Likewise, if the computing system is being heavily used to upload information from system memory into a network—the read percentage would be expected to be higher than the write percentage. Generally, different regions of the system memory's circuitry are utilized depending on whether the system memory is reading data or writing data. As such, should the system memory be utilized with an emphasis toward a particular type of operation (read or write), the system memory's power dissipation would be expected to more closely reflect that expended by the circuitry associated with the emphasized operation.

The page hit/page empty/page miss is a breakdown of: 1) memory page accesses that have successfully resulted in a read or write of data (i.e., a page “hit”); 2) memory page empty accesses (e.g., when a memory controller deliberately moves to a new page to achieve higher efficiency the access pattern is called page empty access); 3) memory page miss access (if the memory controller does not find the desired data in the existing page the page must be closed and new page must be activated). In the event of high “miss” rates, increased “overhead” results. That is, the power consumption of the device increases for a given throughput of information.

The burst length is a description of the number of clock cycles expended to execute a burst read from and/or a burst write to the system memory. Burst reading and/or burst writing is a technique that enhances the operational efficiency of a memory by causing higher order bits of the address bus to remain fixed while lower order bits of the address bus are counted in succession so as to effect a series of operations from memory cells having “neighboring” addresses. Generally, the longer the burst length, the more efficient the memory becomes. As a consequence, the longer the burst length, the less power should be dissipated as compared to the same number of operations that are accomplished by multiple shorter burst sequences.

Memory controllers that are capable of tracking traffic statistics can continually update various aspects of the current state of the system memory's workload. For example, a memory controller configured to keep track of the read/write percentage and page hit/page empty/page miss statistics is capable of continually tracking these aspects of the workload of the system memory. Here, data that reflects the current workload state (e.g., as tracked by the memory controller) and data that reflects the current ambient temperature surrounding the system memory may be used in combination as a “lookup” parameter for fetching a threshold value that is specially suited for the particular, existing workload/temperature condition that the lookup parameter represents.

By so doing, the maximum operational stress that can be applied to the system memory by the memory controller is limited to approximately the best the system memory can handle under the current conditions without significant risk of failure. For example, if the ambient temperature suddenly rises and/or the workload suddenly becomes more stressful, the threshold value may be set lower; or, if the ambient temperature suddenly falls and/or the workload suddenly becomes less stressful, the threshold value may be set higher.

FIG. 5 shows a depiction of a lookup table that presents a special threshold value for any combination of up to N different workloads and M different ambient temperatures. Note that special or unique workloads may apply only for particular types of memory devices. As such, if the lookup table embodied in a computing system conforms to an industry accepted/standardized scheme, some workload columns may be left “blank” in a particular computing system because the particular workload column does not apply for the particular memory device that the particular computing system employs.

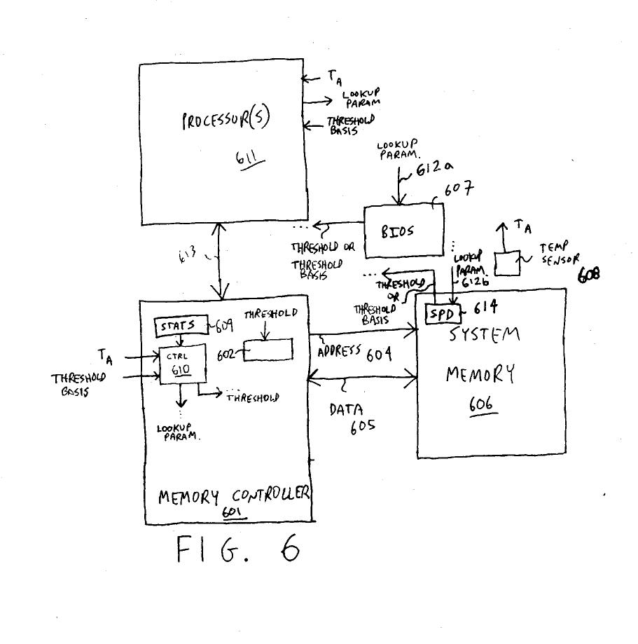

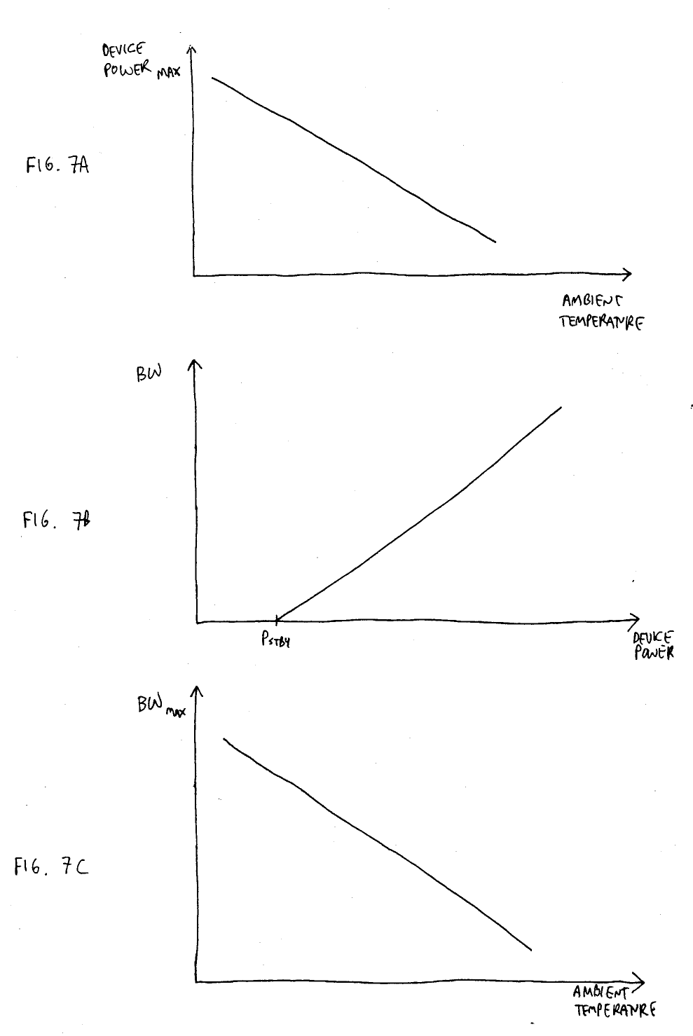

In an embodiment, the computing system's BIOS memory region is used to store the lookup table information (e.g., as depicted in FIG. 5) that provides specially tailored threshold values in response to whatever operating environment presents itself to the system memory. In another embodiment, the computing system's SPD memory region is used to store the lookup table information (e.g., as depicted in FIG. 5) that provides specially tailored threshold values in response to whatever operating environment presents itself to the system memory. FIG. 6 provides a depiction of a computing system whose BIOS memory region 607 or SPD memory region 614 is so configured.

According to the depiction of FIG. 6, the BIOS memory region 607 or the SPD memory region 614 may be presented with a lookup parameter input 612 (e.g., structured as a read address) that represents the current operating environment. In response to the presentation of the lookup parameter input 612, the affected memory region will provide a threshold value (e.g., via a read operation) that is used to control the activity rate applied to the system memory 606. It is expected that in many applications either the BIOS memory region 607 or the SPD memory region 614 is used to store threshold related information. As such, the lookup parameter 612 would be applied to only one of these regions.

As described above, the operating environment may be represented as a combination of the workload and the ambient temperature surrounding the system memory 606. Thus, for example, the ambient temperature is monitored by a temperature sensor 608 that is located proximate to the system memory 606; and, the workload is monitored by one or more traffic statistics registers 609 whose contents represent the manner in which the system memory 606 is being used. From these, the lookup parameter input 612 is crafted; and, in response, the BIOS 607 memory region or SPD memory region 614 (or perhaps other memory or storage region) effectively performs a lookup so as to provide a new threshold value. The new threshold value is loaded into a threshold value register 602 and replaces a less optimal, pre-existing threshold value.

FIG. 6 also indicates that the lookup parameter input 612 may be crafted in a number of different ways by a number of different computing system components. According to one approach, the memory controller 601 includes an embedded control function 610 that creates the lookup parameter 612. The embedded control function 612 may be implemented as an embedded processor or micro-controller that executes software routines related to the construction of the lookup parameter 612. Alternatively, or in some form of combination, dedicated logic may also be used to implement the memory controller's embedded control function 610.

According to another approach, the processor(s) 611 of the computing system are used to construct the lookup parameter 612. Here, the processor(s) 611 receive the memory controller's traffic statistic register 609 contents (e.g., by being passed over front side bus 613) and the ambient temperature from the temperature sensor 611. In even further embodiments, the construction of the input lookup parameter 612 may be shared between the processor(s) 611 and the memory controller 601; and/or, may be entertained by an intelligent entity other than the processor(s) 611 and memory controller 601. Regardless, the function responsible for crafting the input lookup parameter 612 may: 1) repeatedly construct new input lookup parameters at appropriately timed intervals; and/or, 2) cause a new lookup parameter to be specially created in response to a sudden and/or dramatic change in the system memory's operating environment.

Note that use of a lookup table is one way in which new threshold values may be “obtained” during the computing system's operation. In other embodiments, as described in more detail below, the appropriate threshold values may be actively calculated (i.e., “derived”) from specific metrics rather than being obtained by making reference to a pre-existing table of threshold values. Moreover, it should be clear to those of ordinary skill that the resources used to store details sufficient for obtaining or deriving new threshold values may be the BIOS memory region 607, the SPD memory region 614 or some other computing system resource (e.g., another non volatile memory or storage resource).

Techniques By Which Appropriate Threshold Values May Be Determined.

Irrespective of whether new threshold values are looked up or calculated by the computing system, some understanding of “what” threshold is appropriate for a particular type of memory subjected to a particular operating environment should be provided. In various instances, the possible operating environments that a computing system may present to a system memory needs to be related to the specific type of memory used to implement the system memory (e.g., manufacturer, manufacturing process, packing approach, etc.) so that an appropriate threshold can be established for the specific type of memory. Here, if the memory manufacturers themselves do not provide all of the needed threshold values, it is expected that the memory manufacturers make certain information available to those responsible for establishing the appropriate threshold values.

For example, consistent with the embodiments described above, a processor manufacturer and/or computing system manufacturer is customarily regarded as being responsible for the compilation of information to be stored within the computing system's BIOS. As such, should threshold information be tabulated in the computing system BIOS (or elsewhere), a relationship may be established between the memory supplier(s) and the processor/computing system manufacturer(s) so that information sufficient to enlist or derive appropriate threshold values is made available to the processor/computing system manufacturer(s). The following discussion addresses some of these approaches.

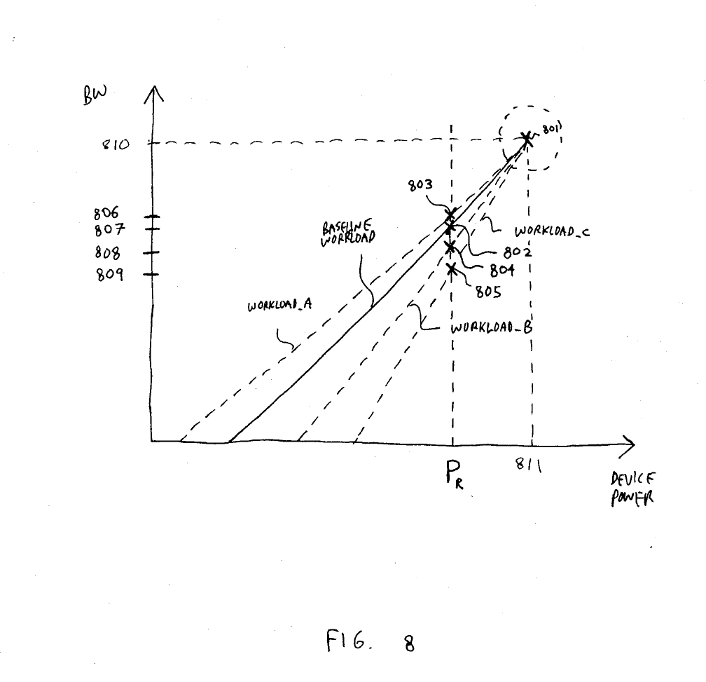

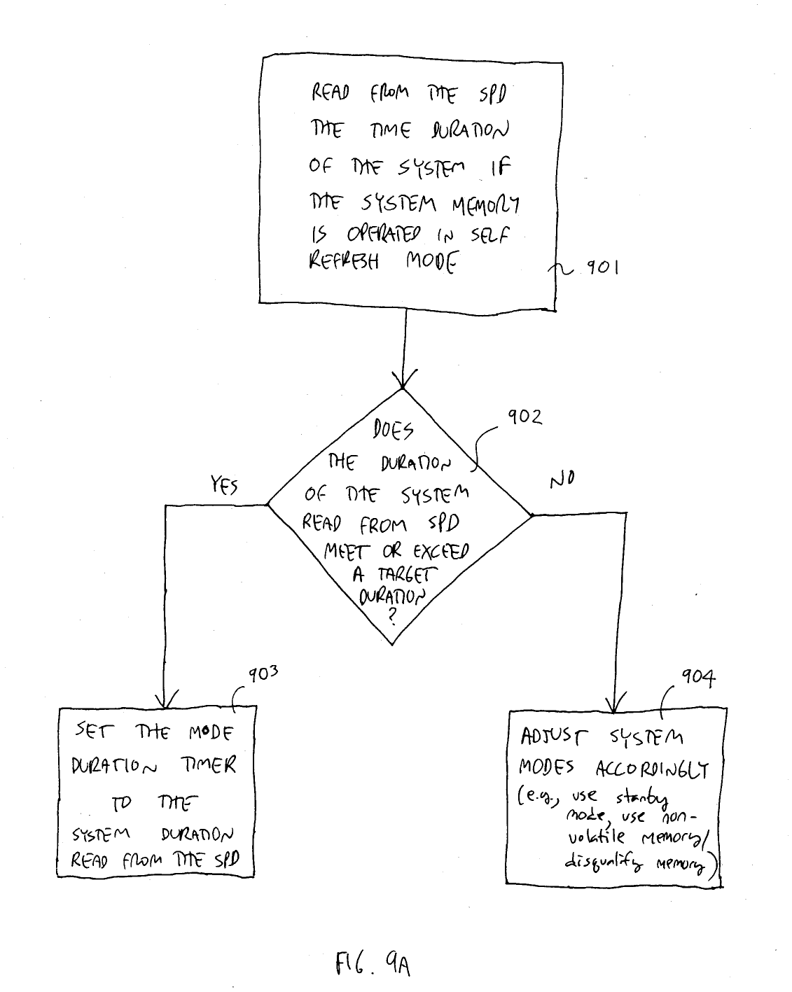

FIGS. 7a through 7c demonstrate a workable relationship that places core competencies on appropriate parties for the purpose of constructing a computing system that can tweak its internal memory control threshold in light of observed changes to the operating environment that its system memory is experiencing. FIG. 7a shows an exemplary depiction of maximum permissible device power vs. ambient temperature for a computing system. The relationship of FIG. 7a generally indicates that as the ambient temperature of a computing system increases, the electrical power that is consumed by a memory device should be reduced so as to prevent the memory device from failing.

Here, it is anticipated that the computing system designer/manufacturer would be best positioned to develop the understanding that FIG. 7a represents. That is the computing system designer, as part of the computing system design process, determines a particular airflow over the system memory and the specific type of system memory devices that will be used in the computing system. Here, the specific type of system memory devices incorporated by the system designer would also be characterized by their packaging type and maximum allowable junction temperature. As junction temperature relates to device power dissipation, from these characteristics (airflow, memory packaging type, maximum junction temperature), a computing system designer can generate the particular “maximum permissible device power vs. ambient temperature” relationship (an example of which is observed in FIG. 7a) for the particular system that is being/has been designed.

FIG. 7b shows a relationship between bandwidth (BW) and memory device power for the particular memory device that has been selected by the computing system designer for the computing system at issue. Moreover, the relationship observed in FIG. 7b is understood to be for a particular workload that the memory device is subjected to. FIG. 7b shows that, under the application of a particular workload (e.g., read/write percentage, page hit/page empty/page miss, burst length, timing conditions, etc.) the higher the activity rate (i.e., “bandwidth” (BW)) applied to a memory device, the more power will be exercised by the memory device. Note that a workload characterizes the usage of a memory in terms of the various types of activities that the memory performs whereas a bandwidth/threshold term corresponds to the rate at which the various types of activities are applied. Ultimately, the specific amount of power consumed by a semiconductor device in response to an applied supply voltage and an applied workload is a product of the semiconductor device's particular electrical design and the particular manufacturing process that was used to manufacture the semiconductor device. As such, it is expected that the memory device supplier is best positioned to develop the relationship observed in FIG. 7b. The memory device supplier can develop the relationship theoretically, experimentally, or some combination thereof.

FIG. 7c amounts to a combination of FIGS. 7a and 7b such that the “device power” variable is eliminated. The result is a correlation of “maximum sustainable bandwidth” (BW_{MAX}) to computing system ambient temperature. The correlation of FIG. 7c can be produced, for example, simply by: 1) mathematically describing the relationship observed in FIG. 7a with a first equation (i.e., a first equation that relates permissible device power to ambient temperature); 2) mathematically describing the relationship observed in FIG. 7b with a second equation (i.e., a second equation that relates device bandwidth to device power for a particular workload); and, 3) combining the pair of equations to produce a third equation that does not have device power as a variable. At the onset, note that the above mathematical process can be applied to behavioral models other than a straight line fit (as such, even though straight lines are observed in FIGS. 7a through 7c; if appropriate, behavioral models other than a straight line may be used). Note that, as a consequence of the combination, the bandwidth parameter of FIG. 7c is interpreted as the “maximum sustainable bandwidth” (BW_{MAX}) because the relationship of FIG. 7a represents “maximum permissible device power”. Better said, the bandwidth at which the maximum permissible device power is reached is represented by the vertical axis of FIG. 7c. The representation of FIG. 7c becomes very useful because, for the workload represented by FIG. 7b, it can be used to generate threshold values for the computing system's memory controller that are tailored for a particular ambient temperature within the computing system and that prevent the computing system's system memory from exceeding its maximum permissible device power when the particular workload is being exercised. Thus, as an example, discrete points of the relationship of FIG. 7c can be tabulated to form one column of lookup values that are observed in FIG. 5. In order to form the complete lookup table observed in FIG. 5, a memory supplier could be asked to generate N relationships as observed in FIG. 7b—i.e., one “BW vs. power” relationship for each workload that is to be recorded in the lookup table in FIG. 5.

Referring now back to FIGS. 7a and 7c, it is important to note that other thermal parameters besides “ambient temperature” may be used as a correlation parameter. For example, to name just a few embodiments, device case temperature may be utilized as the “horizontal” axis in the in the correlation scheme for each of FIGS. 7a and 7c. Device case temperature is readily calculable for any memory package from ambient temperature. Hence, in effect, a measured ambient temperature can be readily converted to a device case temperature. As such, even though ambient temperature may be monitored as part of the scheme, the actual mathematical correlation scheme can be based upon device case temperature rather than ambient temperature. Likewise, case temperature rather than ambient temperature may be actively monitored by the computing system. Therefore, note that memory device case temperature or junction temperature parameters can be stored in a non volatile storage or memory region such as the SPD. For example, a memory supplier may identify the temperature at which his components may exhibit failure modes and store this parameter into the SPD. The system can read this value and adjust the threshold described above to harness additional performance from the device. A subset of the temperature parameters include maximum case temperature and maximum junction temperature that a memory supplier will guarantee its parts to.

Implementation Techniques

The manner in which the “BW vs. power” relationship (FIG. 7b) for each of a plurality of N workloads is to be forwarded from the memory supplier to the computing system designer/manufacturer may vary from embodiment to embodiment. In general, relationship information may be “sent” to the system designer/manufacturer by any technique. Moreover, the form that the relationship information is presented to the system designer/manufacturer may vary from embodiment. In general, the relationship information may be represented by any technique that enables the system designer/manufacturer to understand the relationship.

The manner in which the computing system is configured to ultimately obtain “BW_{MAX} vs. Ambient Temperature” information (FIG. 7c) for each of N workloads may also vary from embodiment. In a basic embodiment, this information is simply stored into the computing system (e.g., within the BIOS memory region 607 or SPD memory region 614) as part of its manufacture. For example, referring back to FIG. 5, M select data points from each of N “BW_{MAX} vs. Ambient Temperature” relationship (i.e., one relationship for each workload) may be configured within the BIOS, SPD or other memory or storage region of a computing system.

In an alternate embodiment, rather than storing M select data points per workload, information sufficient to describe each “BW_{MAX} vs. Ambient Temperature” relationship is stored in the BIOS, SPD or other memory or storage region of a computing system. For example, noting that FIG. 7c has been drawn as a line and noting that only two points are necessary to define a line (e.g., two points from the line or a point from the line and a slope of the line), the BIOS memory region, SPD memory region or other memory or storage region only store two points per workload. From these, the computing system can calculate an appropriate threshold value for the existing operating environment.

FIG. 6 also provides elements of such a system. For example, note that the BIOS or SPD memory regions 607, 614 are depicted as providing either threshold or “threshold basis” information. Here, threshold basis information is any information from which a threshold value may be calculated as opposed to being a pure threshold value. With the preceding embodiment indicating that two points describing a line may be read from the BIOS or SPD, in this case, the BIOS or SPD output corresponds to threshold basis information rather than a threshold value. FIG. 6 indicates that the threshold basis information may be processed by the aforementioned control function 610 to provide the actual threshold value.

Note that according to a further embodiment, the control function 610 may be designed to determine an input lookup parameter from the ambient temperature and/or statistic information so as to extract the correct threshold basis information from the BIOS or SPD memory region and then may reuse the lookup parameter information so as to calculate a proper threshold value from the threshold basis information. Likewise, the processor(s) 611 may instead calculate the threshold value from the threshold basis information and forward it to the memory controller.

From the embodiments described above so far, “BW_{MAX} Vs. Ambient Temperature” relationship information (e.g., FIG. 7c information) is stored in the BIOS or SPD memory regions 607, 614. However, according to at least a family of embodiments, “BW vs. power” information for the system memory (e.g., FIG. 7b information) is stored in the BIOS or SPD memory regions 607, 614. Note that this information still corresponds to threshold basis information. If “BW vs. power” information is stored in the BIOS or SPD memory regions 607, 614, the computing system is responsible for calculating the appropriate threshold through the effective elimination of the device power variable (e.g., as described initially above with respect to the generation of FIG. 7c).

Here, the same calculation techniques described just above with respect to the threshold basis information may be used—with the exception that “Device Power_{MAX} vs. Ambient Temperature” information (e.g., FIG. 7a information) should be included in the threshold basis information. Again, two points may be used to describe a line that characterizes this relationship for any given workload. Therefore, in such an appropriate, four points are stored in the BIOS or SPD for each workload: a first pair of points that describe the “Device Power_{MAX} vs. Ambient Temperature” information (e.g., FIG. 7a information); and, a second pair of points that describe the “BW vs. power” information (e.g., FIG. 7b information). With respect to the storage of the “Device Power_{MAX} vs. Ambient Temperature” information (e.g., FIG. 7a information), note that this information may include the maximum allowable junction or case temperature of a system memory device. Increased ambient temperature has the effect of increasing the junction temperature. Different vendors can tolerate different degrees of junction temperature. Based on a memory vendor's sensitivity to the junction temperature, proportionately its sustainable BW is also impacted. A vendor can therefore also report its tolerable junction temperature or case temperature through the mechanisms established herein. For example, either of these temperature parameters may be stored in the SPD. There exists a fixed relationship between junction temperature and case temperature, namely the juntion to case thermal resistance. This resistance may be different between packages as the underlying packaging technology and performance varies. With respect to the storage of “BW vs. power” information, the two values that are stored per workload may include: 1) a first BW value at a first pre-determined device power; and, 2) a second BW value at a second pre-determined device power. According to a second embodiment, the two values that are provided per workload include: 1) a first BW value at a first pre-determined device power; and, 3) a slope for the applicable line. Here, use of the term “pre-determined” means that there exists an understanding between the memory device supplier and those responsible for performing/designing the mathematical combination approach as to what particular device power a provided BW corresponds to. The pre-determined understanding allows the memory supplier to only report BW values without having to report power values because those responsible for performing the mathematical combination will “understand” the power value for each BW value being provided.

In a further embodiment, for those memory devices that “participate” in the scheme being presented herein, the pre-determined power value(s) are specially selected so that they will intercept any “BW vs. power” curve for any particular type of memory from any particular memory supplier for any particular workload. By so doing, a generic industry wide memory characterization scheme is established that allows a computing system to successfully modulate its threshold value for any “participating” memory device. If any pre-determined power value(s) cannot guarantee an intercept point for one or more particular participating memory devices, it is envisioned that additional “pre-determined” power values cane be added to the family of “pre-determined” power values employed by the generic industry wide scheme. By properly identifying a “pre-determined” power value (e.g., by reference number), it is envisioned that a family of bandwidth values can properly capture every participating memory device.

In another embodiment relating to the storage of BW vs. device power information within the BIOS, SPD or other memory or storage resources of a computing system, represented by FIG. 8, a plurality of “BW vs. power” relationships (e.g., all “BW vs. power” relationships) for a particular memory device are modeled as sharing a common point so as to allow, on average, a full “BW vs. power” relationship to be defined for a workload with less than a pair of stored values. According to the modeling approach of FIG. 8, four workloads (A, B, C and baseline) each are modeled as sharing point 801. Each “X” in FIG. 8 corresponds to a data vale that is stored in the computing system.

For “Xs” 802, 803, 804, 805, the corresponding data value may be stored either as an explicit bandwidth value (e.g., bandwidth values 807, 806, 808 and 809 for “Xs” 802, 803, 804, 805 respectively) or as a slope for its corresponding line. Note that the “baseline workload” relationship is fully defined by the information stored in the SPD because there are two stored points (801, 802). Workloads A, B, C however can be fully understood with the understanding that point 801 of the baseline workload is to be used for these workloads and by only one extra point per workload (i.e., point 803 for workload A, point 804 for workload B and point 805 for workload C).

As such, five SPD values are stored to represent four workloads; and, the ratio of stored SPD values is much closer to 1.0 than 2.0. Note that each of points 802 through 805 can be viewed as being “pre-determined” for power level P_{R}. With the predetermination of the power level of point 801, an appropriate combination can be made for each of the four workloads so as to provide “BW_{MAX} vs. Ambient Temperature” information for each of the four workloads. In a further embodiment, the “endpoint” 801 may be specified by a “max bandwidth” and a “max device power” (represented in FIG. 8 by points 810 and 811). Note also that any of data points 802 through 805 could be “replaced” in the SPD with a slope value. Also note that the slope of 801, that is 810 divided by 811, can also be stored in SPD for each workload. Here 810 is the BW corresponding to 801, and 811 is the power corresponding to 801.

The metrics that are analytically established here can also be established through test and measurement. The assumptions made about the environment, workload and the power budget can be taken as the test input conditions under which the memory is tested. The resulting bandwidth using the pre-determined test criteria can be reported to the system integrator as described herein. Measuring each memory unit eliminates any uncertainty about the component values, whereas, analytical techniques may assume a worst case value for all parameter for the devices in a class. Since all the parameters that govern power and yield become a probability distribution function, the analytical cases should account for the worst case parameters. For those devices that are well below the worst case values, the system may be able to harness additional performance headroom. Test and measurement would allow the memory component manufacturer to accurately place the device on a distribution graph.

Determining Whether A System Should Operate With A Self Refreshed System Memory

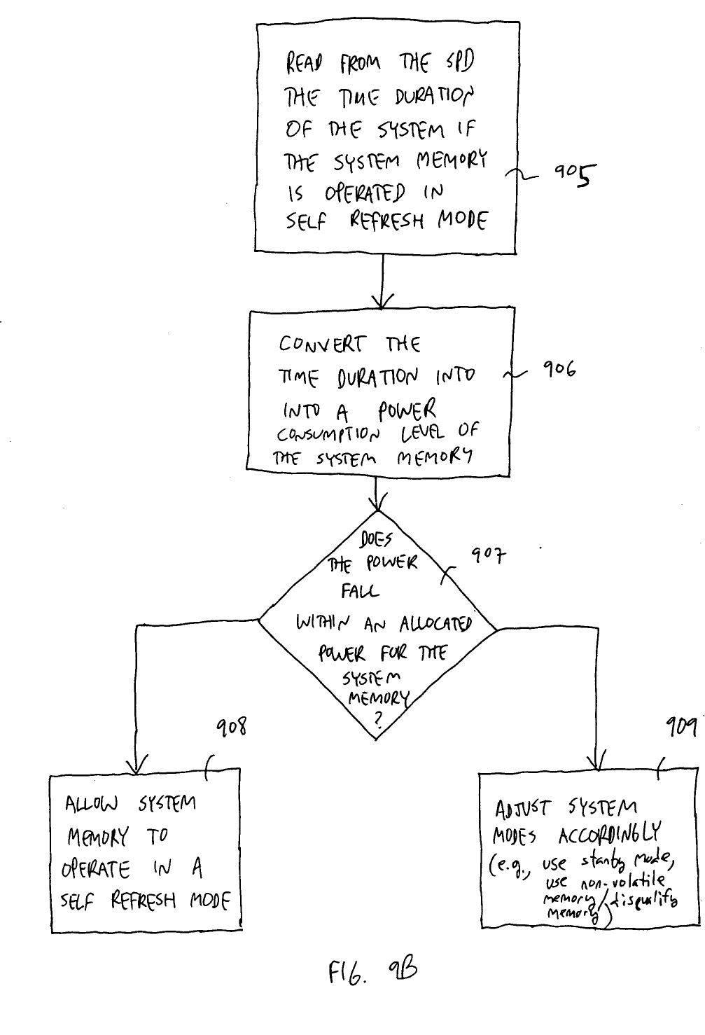

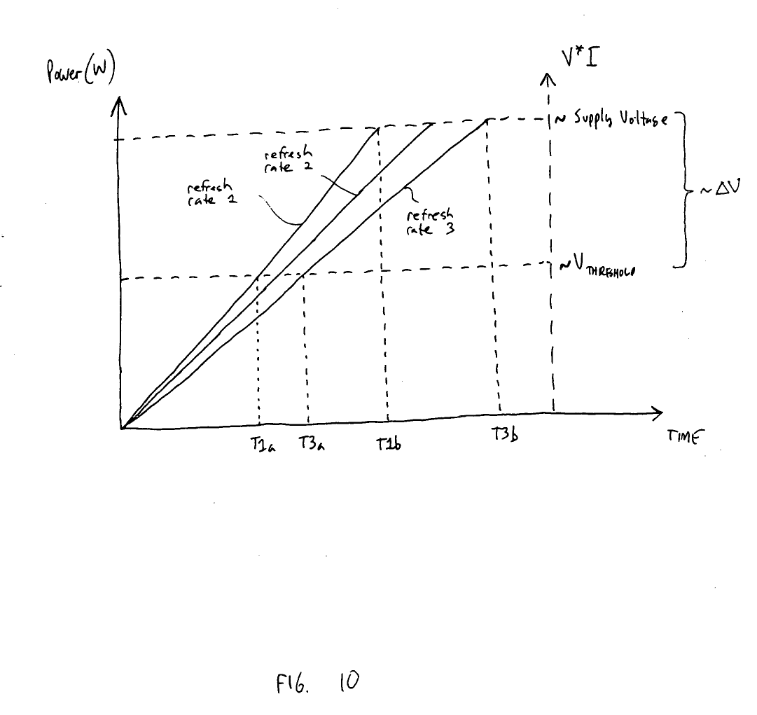

FIGS. 9a and 9b show techniques for preventing a functional failure with respect to the operation of a computing system's system memory. In the case of the methodology of FIG. 9a, a “time duration” parameter, which may be stored in a non volatile resource such as a BIOS memory region or SPD memory region, is used to determine 902 whether or not the computing system is capable of operating the system memory in a self refresh mode. In particular, the stored time duration parameter identifies the extent in time the computing system may properly operate with its system memory operating in a self refresh mode. Notably, a system memory's self refresh mode consumes power at a sufficient level so as to have an impact on the length of time a battery powered computing system can properly operate. As such, the stored time duration parameter is expected to be particularly useful for battery operated systems because it reflects how long the computing system can be expected to operate under battery power, with its system memory operating in a self refresh mode, before the battery's potential depletes to the point where the computing system begins to suffer functional failures.

According to the methodology of FIG. 9a, after the time duration parameter is read 901 from a memory or storage resource such as the SPD memory region, the computing system compares it against a “target” duration that is established for the computing system. In a further embodiment, the “target” duration corresponds to a time duration recognized by the computing system's operating system (OS) as a “standby mode duration”. If the stored duration time meets or exceeds the “target” duration time, a mode duration timer is set equal to time duration parameter 903. Here, the mode duration timer is used to track available time left before a functional failure might occur.

By setting the mode duration time equal to the read time duration parameter 903, the computing system will properly track the length of time in which the system memory can operate in self refresh mode within the computing system without causing a functional failure. If the stored duration time does not meet or exceed the “target” duration time, the self refresh mode is identified as being improper for the system memory and an alternative system mode is effected 904. For example, the system memory may be placed into a standby mode, the system memory may be “disqualified” (e.g., formally recognized as being unusable), or the system memory's contents may be stored to a non volatile storage device such as a hard disk drive.

According to one technique the duration in which the self refresh mode can be reliably sustained, under a fixed power budget, is quantified. The power budget may represent the charge capacity of a standard portable computer battery. Since battery capacity can vary, it will be convenient to convey this information mathematically. The available charge may be modeled as a linear function of power consumption. If two points of this line are provided, one can easily and deterministically calculate all other points. These two points may be chosen arbitrarily to ensure meaningful linear or piece-wise linear data. The available charge is depleted quicker if the refresh rate or other activity increases. As the refresh rate increases, the power consumption increases proportionately. Multiple slope lines can represent various refresh rates.

Multiple power points may be specified to obtain corresponding points along the time axis, as shown in FIG. 10. In an embodiment, the reliability of the unit under operation is judged by acceptable voltage drop. If the voltage drop is significant enough to lead to a malfunction of the device, the time at which such an event happens is taken as the point (t). A family of curves can be generated to address multiple refresh rates.

The following equations shows the variabless considered.

P=Δt*ΔV*I EQN. 1

Δt=P/ΔV*I EQN. 2

For simplicity sake, a constant current source is assumed. The power variable ‘P’ in the above equations can be arbitrarily chosen. ΔV represents the voltage drop from the ideal state to a state at which the device would malfunction. The state at which the device malfunctions, referred to also as V_{Threshold} Δt, is taken from the graph as T3b−T3a. T3b represents the slope, computed at the ideal voltage and constant current as a function of power budget, as in Equation 3 below

T3b=P_{Budget}/V_{ideal}*I_{ccs} EQN. 3

Once these variables are defined, one can easily construct the lines representing the power consumption. In response to the available power budget and the pre-determined V_{Threshold}, the corresponding values on the time axis may be programmed into a non volatile storage or memory resource (e.g., BIOS memory region or SPD memory region) or may be conveyed to the host system using any other consistent means. Alternatively, just the slope may be programmed indicating the ratio.

FIG. 9b demonstrates a similar methodology except that power, rather than time, is used as a basis for comparison 907. According to the methodology of FIG. 9b, a time duration parameter like that described above with respect to FIG. 9a is stored in a non volatile storage or memory resource (such as a BIOS or SPD memory region). After the time duration parameter is read 905 from the memory or storage resource, the computing system converts 906 it to a power consumption level for the system memory while in self refresh mode (e.g., be coverting system time duration into system power consumption and then removing power consumption contributions attributable to system components other than the system memory), and compares 907 it against a “designed for” power consumption that has been allocated for the system memory in self refresh mode.

If the power parameter falls within (i.e., is less than or equal to) the allocated for power, the system memory is allowed to operate in a self refresh mode 908. If the power parameter does not fall within the allocated for power value, the self refresh mode is identified as being improper for the system memory and an alternative system mode is used instead 909. For example, the system memory may be placed into a standby mode, the system memory may be “disqualified” (e.g., formally recognized as being unusable), or the system memory's contents may be stored to a non volatile storage device such as a hard disk drive.

Note that, similar to the methodologies described elsewhere in this application, either of the methodologies described above with respect to FIGS. 9a and 9b may be executed with software by the computing system's processors or by dedicated hardware (e.g., logic) or by some combination of software and dedicated hardware. With respect to those implementations performed with software, the instructions for performing a function may stored on a machine readable medium.

A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
a) reading information from a non volatile storage or memory resource, said information being a threshold or information from which a threshold can be calculated, said information particularly tailored for an operating environment of said a system memory; and,
b) causing a memory controller to employ said threshold so as to control a rate at which said memory performs activities, said rate less than that at which said system memory would experience a functional failure while being subjected to said operating environment.

2. The method of claim 1 wherein said operating environment is at least partially defined by a temperature and workload.

3. The method of claim 2 wherein said temperature is a case temperature of said system memory.

4. The method of claim 2 wherein said temperature is an ambient temperature of said system memory.

5. The method of claim 2 wherein said temperature is a junction temperature of said system memory.

6. The method of claim 2 wherein said workload is at least partially defined by traffic statistics maintained by said memory controller.

7. The method of claim 2 wherein said workload is at least partially defined by said system memory's reading and writing activity

8. The method of claim 7 wherein said workload is at least partially defined by said system memory's read/write percentage.

9. The method of claim 2 wherein said workload is at least partially defined by said system memory's page hit, page empty and page miss activities.

10. The method of claim 9 wherein said workload is at least partially defined by said system memory's page hit/page empty/page miss percentage.

11. The method of claim 1 wherein said non volatile storage or memory resource is a BIOS memory region.

12. The method of claim 1 wherein said non volatile storage or memory resource is an SPD memory region.

13. The method of claim 12 wherein said SPD is configured to have a specially tailored threshold value for each of a plurality of different workloads and temperatures.

14. The method of claim 12 wherein said SPD is configured to have a pair of points that describe a line for each of a plurality of different workloads.

15. The method of claim 14 wherein said line is a line that characterizes maximum allowable bandwidth vs. temperature.

16. The method of claim 14 wherein said line is a line that characterizes bandwidth vs. power.

17. The method of claim 12 wherein said SPD is configured to represent a plurality of lines with less than two points per line because said lines are modeled as sharing a common point.

18. The method of claim 1 further comprising establishing a system memory component's case or junction temperature sensitivity to component functionality and relaying said sensitivity to a system or processor supplier.

19. The method of claim 18 where said establishing further comprises establishing through test and measurement.

20. A computing system, comprising:
a) a system memory;
b) a non volatile storage or memory resource having information, said information being a threshold or information from which a threshold can be calculated, said information particularly tailored for an operating environment that said system memory is recognized as being subjected to; and,
c) a memory controller to employ said threshold so as to control a rate at which said memory performs activities, said rate less than that at which said system memory would experience a functional failure while being subjected to said operating environment.

21. The apparatus of claim 2Q wherein said operating environment is at least partially defined by a temperature and workload.

22. The apparatus of claim 21 wherein said temperature is a case temperature of said system memory.

23. The apparatus of claim 21 wherein said temperature is an ambient temperature of said system memory.

24. The apparatus of claim 21 wherein said workload is at least partially defined by traffic statistics maintained by said memory controller.

25. The apparatus of claim 21 wherein said workload is at least partially defined by said system memory's reading and writing activity.

26. The apparatus of claim 25 wherein said workload is at least partially defined by said system memory's read/write percentage.

27. The apparatus of claim 21 wherein said workload is at least partially defined by said system memory's page hit, page empty and page miss activities.

28. The apparatus of claim 27 wherein said workload is at least partially defined by said system memory's page hit/page empty/page miss percentage.

29. The apparatus of claim 20 wherein said non volatile storage or memory resource is a BIOS memory region.

30. The apparatus of claim 20 wherein said non volatile storage or memory resource is an SPD memory region.

31. The apparatus of claim 30 wherein said SPD is configured to have a specially tailored threshold value for each of a plurality of different workloads and temperatures.

32. The apparatus of claim 30 wherein said SPD is configured to have a pair of points that describe a line for each of a plurality of different workloads.

33. The apparatus of claim 32 wherein said line is a line that characterizes maximum allowable bandwidth vs. temperature.

34. The apparatus of claim 32 wherein said line is a line that characterizes bandwidth vs. power.

35. The apparatus of claim 30 wherein said SPD is configured to represent a plurality of lines with less than two points per line because said lines are modeled as sharing a common point.

36. A machine readable medium having stored thereon a sequence of instructions which when executed by one or more processors cause said one or more processors to perform a method, said method comprising:
a) causing information to be read from a non volatile storage or memory resource, said information being a threshold or information from which a threshold can be calculated, said information particularly tailored for an operating environment of said a system memory; and,
b) causing a memory controller to employ said threshold so as to control a rate at which said memory performs activities, said rate less than that at which said system memory would experience a functional failure while being subjected to said operating environment.

37. The machine readable medium of claim 36 wherein said operating environment is at least partially defined by a temperature and workload.

38. The machine readable medium of claim 37 wherein said temperature is a case temperature of said system memory.

39. The machine readable medium of claim 37 wherein said temperature is an ambient temperature of said system memory.

40. The machine readable medium of claim 37 wherein said temperature is a junction temperature of said system memory.

41. The machine readable medium of claim 37 wherein said workload is at least partially defined by traffic statistics maintained by said memory controller.

42. The machine readable medium of claim 37 wherein said workload is at least partially defined by said system memory's reading and writing activity

43. The machine readable medium of claim 42 wherein said workload is at least partially defined by said system memory's read/write percentage.

44. The machine readable medium of claim 37 wherein said workload is at least partially defined by said system memory's page hit, page empty and page miss activities.

45. The machine readable medium of claim 44 wherein said workload is at least partially defined by said system memory's page hit/page empty/page miss percentage.

46. The machine readable medium of claim 36 wherein said non volatile storage or memory resource is a BIOS memory region.

47. The machine readable medium of claim 36 wherein said non volatile storage or memory resource is an SPD memory region.

48. The machine readable medium of claim 47 wherein said SPD is configured to have a specially tailored threshold value for each of a plurality of different workloads and temperatures.

49. The machine readable medium of claim 47 wherein said SPD is configured to have a pair of points that describe a line for each of a plurality of different workloads.

50. The machine readable medium of claim 49 wherein said line is a line that characterizes maximum allowable bandwidth vs. temperature.

51. The machine readable medium of claim 49 wherein said line is a line that characterizes bandwidth vs. power.

52. The machine readable medium of claim 47 wherein said SPD is configured to represent a plurality of lines with less than two points per line because said lines are modeled as sharing a common point.

53. A method, comprising:
a) reading information from an SPD memory region, said information being a threshold or information from which a threshold can be calculated, said information particularly tailored for an operating environment of said a system memory; and,
b) causing a memory controller to employ said threshold so as to control a rate at which said memory performs activities, said rate less than that at which said system memory would experience a functional failure while being subjected to said operating environment.

54. The method of claim 53 wherein said operating environment is at least partially defined by a temperature and workload.

55. The method of claim 54 wherein said temperature is a case temperature of said system memory.

56. The method of claim 54 wherein said temperature is an ambient temperature of said system memory.

57. The method of claim 54 wherein said temperature is a junction temperature of said system memory.

58. The method of claim 54 wherein said workload is at least partially defined by traffic statistics maintained by said memory controller.

59. The method of claim 54 wherein said workload is at least partially defined by said system memory's reading and writing activity

60. The method of claim 52 wherein said workload is at least partially defined by said system memory's read/write percentage.

61. The method of claim 54 wherein said workload is at least partially defined by said system memory's page hit, page empty and page miss activities.

62. The method of claim 61 wherein said workload is at least partially defined by said system memory's page hit/page empty/page miss percentage.

63. A method, comprising:
a) reading information from a non volatile storage or memory resource that indicates a time duration that a computing system is expected to operate without functional failure while said computing system's system memory operates in a self refresh mode; and,
b) allowing said system memory to operate in a self refresh mode if said time duration is less than a target time duration established for said computing system.

64. The method of claim 63 wherein said target time duration is a standby mode duration time.

65. The method of claim 63 further comprising causing said system memory to enter into a standby mode if said time duration is greater than said target time duration.

66. The method of claim 53 further comprising disqualifying said system memory if said time duration is greater than said target time duration.

67. The method of claim 63 further comprising storing the contents of said system memory to a hard disk drive if said time duration is greater than said target time duration.

68. A method, comprising:
a) reading information from a non volatile storage or memory resource that indicates a time duration that a computing system is expected to operate without functional failure while said computing system's system memory operates in a self refresh mode;
b) converting said time duration to a power of said system memory while said system memory operates in said self refresh mode
c) allowing said system memory to operate in a self refresh mode if said power is within an allocated power for said system memory.

69. The method of claim 68 further comprising causing said system memory to enter into a standby mode if said time duration is greater than said target time duration.

70. The method of claim 68 further comprising disqualifying said system memory if said time duration is greater than said target time duration.

71. The method of claim 68 further comprising storing the contents of said system memory to a hard disk drive if said time duration is greater than said target time duration.
